(19) United States
(12) Patent Application Publication
(10) Pub. No.: US 2025/0206020 A1
(43) Pub. Date: Jun. 26, 2025

(54) LIQUID EJECTION HEAD SUBSTRATE

(71) Applicant: CANON KABUSHIKI KAISHA, Tokyo (JP)

(72) Inventors: TAKERU YASUDA, Kanagawa (JP); SHINYA IWAHASHI, Kanagawa (JP)

(21) Appl. No.: 18/989,263

(22) Filed: Dec. 20, 2024

(30) Foreign Application Priority Data
Dec. 20, 2023 (JP) 2023-214567

(51) Int. Cl. B41J 2/14

(52) U.S. Cl. CPC B41J 2/14129; B41J 2/14072; B41J 2202/08

(57) ABSTRACT

A liquid ejection head substrate in which a first insulating layer, a wiring layer, and a second insulating layer are stacked in this order on a substrate is used in which a heat generating resistive layer configured to generate energy for ejecting liquid by electrification is provided on the second insulating layer, a connection plug that extends through the second insulating layer, electrically connects the wiring layer and the heat generating resistive layer, and enables electrification of the heat generating resistive layer is included, and a film thickness from the first insulating layer to the second insulating layer in a first region that coincides with the heat generating resistive layer in plan view is thinner than a film thickness from the first insulating layer to the second insulating layer in a second region that does not coincide with the heat generating resistive layer in plan view.

### BACKGROUND OF THE INVENTION

### Field of the Invention

The present invention relates to a liquid ejection head substrate.

### Description of the Related Art

A liquid ejection apparatus, such as an inkjet recording apparatus, uses a liquid ejection head including an element substrate. Heat generating resistive elements for heating liquid are used in the vicinity of the element substrate. A typical configuration of a conventional liquid ejection head (also referred to as a recording head, hereinafter simply referred to as a “head”) is now described. The head includes multiple ejection ports and heat generating resistive elements provided on a substrate. A pair of electric wiring lines is connected to each heat generating resistive element, and the portion sandwiched between the ends of the pair of electric wiring lines defines the substantial region of the heat generating resistive element. The electric wiring lines are provided on the rear surface of the heat generating resistive element as viewed from the substrate, that is, on the ejection port side of the heat generating resistive element. To protect the electric wiring lines and the heat generating resistive elements from liquid, the electric wiring lines and the heat generating resistive elements are covered with a protection film. When a current is applied from the electric wiring lines to the heat generating resistive elements, the heat generating resistive elements generate heat, and film boiling occurs in the liquid such as ink. This creates air bubbles, which cause the liquid to be ejected from the ejection openings, thereby performing recording. A large number of ejection ports and heat generating resistive elements can be easily arranged at high density in such a head, allowing for the obtainment of high-definition recorded images.

In recent years, an increase in the number of ejection ports and increased ejection speed have increased the power consumption of the head. To reduce the power consumption of the liquid ejection head, it is important to efficiently transfer the heat of the heat generating resistive elements to liquid. For this purpose, it is effective to reduce the thickness of the protection film that covers the heat generating resistive elements. On the other hand, a certain film thickness is required to ensure the protection performance of the protection film for the electric wiring and the heat generating resistive element. In particular, since the electric wiring is generally thicker than the heat generating resistive element, a large film thickness is required to reliably cover the step at the boundary between the electric wiring and the heat generating resistive element.

In this regard, Japanese Patent Application Publication No. 2016-137705 describes a configuration in which a connection member having a plug structure is placed on the rear surface of a heat generating element as viewed from the ejection port direction in order to supply power to the heat generating resistive element. The use of such a configuration allows the surface including the heat generating resistive elements to be planarized as much as possible and reduces the thickness of the protection film.

### SUMMARY OF THE INVENTION

However, when the above-mentioned plug structure is adopted, the insulating layer for forming the plug needs to be planarized by a method such as chemical mechanical polishing. In this case, to secure the function of the insulating film after polishing, the insulating film thickness needs to be designed taking into account the film thickness that is reduced by polishing. For this reason, the film thickness needs to be designed to be thicker than that in a normal configuration that does not involve planarization. In particular, the insulating film placed directly below the heat generating resistive element functions as a heat storage layer, which stores energy for heat generation. The film thickness design of the heat storage layer is an important factor in maintaining a balance between the heat dissipation and heat storage of the thermal energy generated in the heat generating resistive element. Specifically, if the heat storage layer is thick, the heat dissipation efficiency decreases. This may cause unnecessary boiling of the ejected liquid that is refilled onto the heat generating resistive element, resulting in problems such as unintended liquid ejection. Also, insufficient heat dissipation may cause the temperature of the entire liquid ejection head to gradually rise. This may activate the safety mechanism typically installed in the liquid ejection device, leading to increased downtime of the apparatus.

The present invention has been made in view of the above issues. It is an object of the present invention to provide an element substrate for a liquid ejection head that can limit an increase in the film thickness of a heat storage layer even when a configuration is adopted in which a connection member of a plug structure is placed on the rear surface of a heat generating element.

The present invention provides a liquid ejection head substrate in which a first insulating layer, a wiring layer, and a second insulating layer are stacked in this order on a substrate, wherein
a heat generating resistive layer configured to generate energy for ejecting liquid by electrification is provided on the second insulating layer,
a connection plug that extends through the second insulating layer, electrically connects the wiring layer and the heat generating resistive layer, and enables electrification of the heat generating resistive layer is included, and
a film thickness from the first insulating layer to the second insulating layer in a first region that coincides with the heat generating resistive layer in plan view is thinner than a film thickness from the first insulating layer to the second insulating layer in a second region that does not coincide with the heat generating resistive layer in plan view.

According to the present invention, it is possible to provide an element substrate for a liquid ejection head that can reduce the thickness of a heat storage layer and improve the heat dissipation properties even when the surface including a heat generating resistive element is planarized as much as possible and the thickness of the protection film is reduced.

Further features of the present invention will become apparent from the following description of exemplary embodiments with reference to the attached drawings.

### BRIEF DESCRIPTION OF THE DRAWINGS

FIGS. 1A and 1B are top views of a liquid ejection head substrate to which the present invention can be applied;

FIG. 2 is a cross-sectional view of a liquid ejection head substrate according to a first embodiment;

FIG. 3 is a cross-sectional view of a liquid ejection head substrate according to a second embodiment;

FIG. 4 is a cross-sectional view of a liquid ejection head substrate according to a third embodiment;

FIG. 5 is a cross-sectional view of a liquid ejection head substrate according to a fourth embodiment;

FIG. 6 is a cross-sectional view of a liquid ejection head substrate according to a first comparative example;

FIG. 7 is a cross-sectional view of a liquid ejection head substrate according to a second comparative example; and

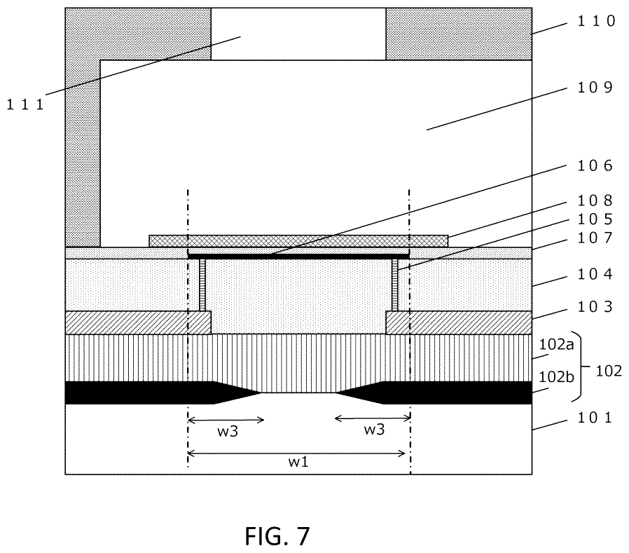

FIG. 8 is a schematic view of a liquid ejection apparatus to which the present invention is applied.

### DESCRIPTION OF THE EMBODIMENTS

Referring to the drawings, exemplary embodiments of the present invention will be described in detail. However, the dimensions, materials, shapes, relative arrangements, and the like of the components described in these embodiments are not intended to limit the scope of the present invention thereto unless otherwise specified. Also, the materials, shapes, and the like of the members once described in the following description will be the same in the subsequent description as in the initial description unless otherwise specified. For configurations and steps not specifically shown or described, well-known or publicly known techniques in the relevant technical field can be applied. Additionally, duplicated explanations may be omitted.

### First Embodiment

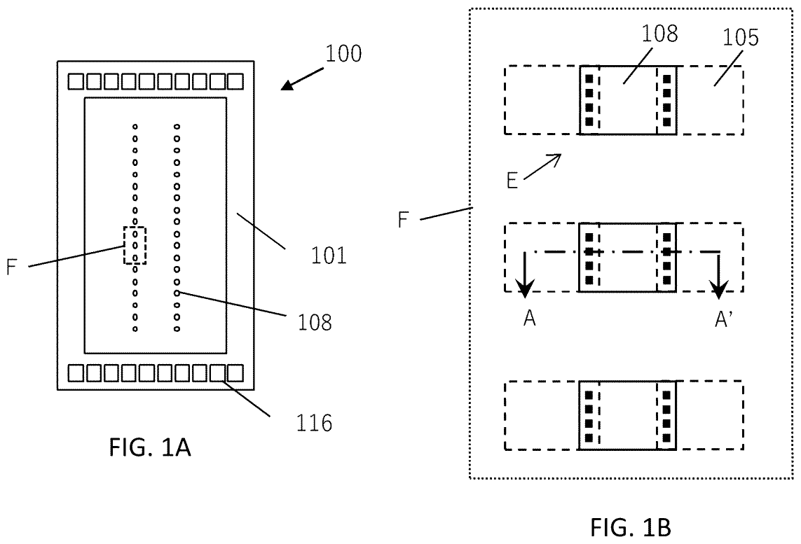

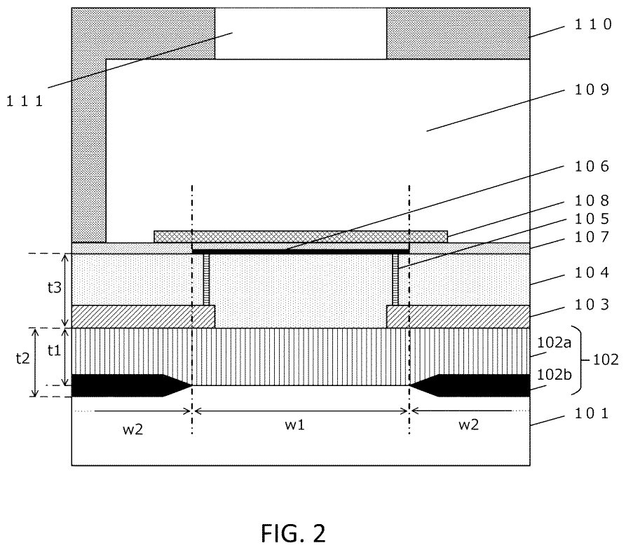

Referring to FIGS. 1A, 1B, and 2, a first embodiment of the present invention is now described. FIGS. 1A and 1B are schematic top views of a heat generating resistive element portion of a liquid ejection head substrate 100 (also referred to as an element substrate, hereinafter simply referred to as “substrate 100”). FIG. 1A is an overall plan view, and FIG. 1B is an enlarged view of section F indicated by a dashed line in FIG. 1A. FIG. 2 is a schematic view showing a cross section taken along line A-A′ in FIG. 1B of the first embodiment.

In general, in the manufacturing process of a liquid ejection head, multiple layers are stacked on a base substrate 101 made of Si, with driving circuits built in advance in the base substrate 101. As such, semiconductor elements such as switching transistors for selectively driving the heat generating elements, for example, are also built into the base substrate 101 in advance as driving circuits, and the liquid ejection head substrate 100 is formed by stacking layers on the base substrate 101. However, for the sake of simplicity, FIGS. 1A, 1B, and 2 only show the base substrate 101, and pre-arranged driving circuits and the like are omitted.

As shown in FIG. 2, in this embodiment, a first insulating layer 102 made of an insulating material such as SiO is formed on a Si base substrate 101 to a thickness of 0.5 to 2 μm, and then a wiring layer 103 is formed to a thickness of 0.2 to 1.5 μm using a material mainly composed of a metal such as Al or Cu. For the base substrate 101 in which driving circuits are built in advance, at least a part of the first insulating layer 102 can be formed during the manufacturing process of the driving circuits. FIGS. 1A and 1B show a state in which the flow passage forming member is removed, a functional portion having a region for heat generating elements E is provided in the central portion of the base substrate 101, and external connection terminals 116 are provided in peripheral portions.

Next, a second insulating layer 104 made of SiO or the like is formed on the wiring layer 103 to a thickness of 0.3 to 2.5 μm, and then a surface planarization process such as chemical mechanical polishing is performed to reduce the steps of the second insulating layer 104. At this time, the planarization process is performed such that the second insulating layer 104 located on the wiring layer 103 has a thickness of 0.2 to 2.4 μm. In this embodiment, the surface planarization process is performed only after the second insulating layer 104 is formed, but the surface planarization process may be performed after the first insulating layer 102 is formed or in any other step. However, to simplify the manufacturing process, the number of surfaces that are subjected to the planarization treatment is preferably two or less, and more preferably one.

Subsequently, a connection plug 105 made of tungsten (W) or the like is formed so as to extend through the second insulating layer 104 and reach the wiring layer 103. The connection plug 105 may be formed by a method in which the region of the second insulating layer to form the connection plug 105 is opened by photolithography and dry etching, a film of W is formed by CVD, and unnecessary part of W is removed by dry etching. Of course, the connection plug 105 may be formed by other methods. For example, a layer having a function of preventing diffusion, such as Ti, may be formed under W.

Then, a heat generating resistive layer 106 is formed with a resistance material containing Ta, W, Si, and the like to a thickness of 5 to 30 nm so as to be electrically connected to the wiring layer 103 via the connection plug 105. Furthermore, a protection layer 107 made of SiN or the like is formed to a thickness of 50 to 400 nm so as to cover the heat generating resistive layer 106. Additionally, a metal protection layer made of Ta or the like or a functional layer, such as an adhesive layer between the flow passage forming member and the substrate, may be placed on the protection layer 107. The heat generating element portion is fabricated in this manner. When a voltage is applied from a power source via the wiring layer 103 and the connection plug 105, the heat generating resistive layer 106 generates thermal energy and heats the liquid.

In this embodiment, the first insulating layer 102 is formed by stacking a SiO layer 102a (first layer), which is formed by plasma CVD, and a thermal oxide layer 102b (second layer), which is a thermal oxide film formed by thermal oxidation of Si. In manufacturing, patterning is performed so as not to form the thermal oxide layer 102b in the region (first region w1) that coincides with the heat generating resistive layer 106 in plan view. The thermal oxide layer 102b is formed in a region (second region w2) that does not coincide with the heat generating resistive layer 106 in plan view. By forming the first insulating layer 102 in this manner, the film thickness (t1) of the region of the first insulating layer 102 that functions as a heat storage layer located directly below the heat generating resistive layer 106 is thinner than the film thickness (t2) of the other regions. As a result, the heat dissipation efficiency can be improved. Furthermore, in the region that does not include the heat generating element but includes the wiring layer 103, the thickness of the insulating layer can be increased, ensuring sufficient insulation.

On the base substrate 101 including the heat generating element fabricated as described above, a flow passage forming member 110, which forms a flow passage for supplying liquid and a pressure chamber for supplying pressure for ejection, is formed using a material such as epoxy resin. Finally, an ejection port 111 for ejecting liquid is formed in the portion of the pressure chambers opposed to the heat generating resistive layer 106, thereby completing the manufacture of the substrate 100 of this embodiment.

### Specific Configuration and Manufacturing Method

A more specific configuration of the above-mentioned first embodiment is now described, including a manufacturing method. First, a base substrate 101 is prepared in which semiconductor elements, such as switching transistors for selectively driving heat generating elements, are built as driving circuits on a Si substrate in advance. Here, in the process of forming the driving circuits, a SiN film is formed by thermal CVD so as to cover at least the region in which a heat generating element is to be formed later in plan view, and is patterned by photolithography. Then, a SiO2 film is formed to a thickness of 1.0 μm in the region excluding the heat generating element region by thermal oxidation using an oxidation furnace, and the SiN film in the heat generating element region is removed by wet etching to form a portion of the first insulating layer 102 in advance.

Next, the first insulating layer 102 is formed by depositing a SiO:H film to a thickness of 1.0 μm by plasma CVD. Furthermore, an AlCu film is formed to a thickness of 0.5 μm by sputtering. Then, after patterning using photolithography, the wiring layer 103 is formed by removing the film leaving the portion that is to be the wiring layer 103 by dry etching using a chlorine-based gas. Then, the SiO:H film is formed to a thickness of 2.5 μm again by plasma CVD. Then, the unevenness caused by the pattern of the wiring layer 103 is removed by polishing using CMP so that the film thickness on the wiring layer 103 becomes 1.0 μm, thereby forming the second insulating layer 104. At this time, the film thickness (t3) of the second insulating layer 104 in the region where the wiring layer 103 is not located is 1.5 μm.

Next, a part of the region of the second insulating layer 104 that coincides with the wiring layer 103 in plan view is patterned by photolithography, and dry etching is performed using a fluorine-based gas to form an opening reaching the wiring layer 103. The open region is filled with W by depositing W by metal CVD, and then unnecessary part of W that is deposited in areas other than the inside of the opening of the second insulating layer 104 is removed by polishing using CMP to form a connection plug 105.

Furthermore, a heat generating resistive layer 106 made of TaSiN is formed by sputtering to a thickness of 15 nm so as to be electrically connected to the connection plug 105. Then, the region to form a heat generating element is patterned by photolithography, and unnecessary part is removed by dry etching using a chlorine-based gas, thereby forming a heat generating resistive layer 106. Then, a protection layer 107 made of SiN is formed to a thickness of 300 nm by plasma CVD. Furthermore, a metal protection layer 108 made of Ta is formed thereon by sputtering, and is patterned by photolithography so as to cover the heat generating resistive layer 106. Then, unnecessary part is removed by dry etching using a chlorine-based gas.

Furthermore, a resist is applied onto the prepared substrate by spin coating as a dissolvable solid layer that will eventually become a liquid chamber 109. The resist material is made of, for example, polymethylisopropenylketone, and acts as a negative resist. Then, the resist layer is patterned into the desired shape of the liquid chamber 109 using photolithography. The liquid chamber 109 functions as a container for storing liquid such as ink.

Next, to form liquid flow passage walls forming the flow passage forming member 110 and an ejection port 111, a coating resin layer is formed. Before forming this coating resin layer, a silane coupling treatment or the like may be appropriately performed to improve adhesion. The coating resin layer can be formed by applying a resin to the liquid ejection head substrate on which the liquid chamber pattern of the liquid chamber 109 is formed, using a conventionally known coating method that is appropriately selected. Next, the coating resin layer is patterned into the desired shapes of the liquid flow passage walls and the ejection port by photolithography. Then, a liquid supply port is formed from the rear surface of the substrate by anisotropic etching, sandblasting, anisotropic plasma etching, or the like (not shown). Most preferably, the liquid supply port may be formed by a chemical silicon anisotropic etching method using tetramethylhydroxyamine (TMAH), NaOH, KOH, or the like. This is followed by overall exposure to Deep-UV light, development, and drying to remove the dissolvable solid layer.

Through the above steps, the liquid ejection head substrate 100 is manufactured. In this embodiment, the heat storage layer located directly below the heat generating resistive layer 106 has a thickness of 2.5 μm, which is equal to the distance from the heat generating resistive layer 106 to the base substrate 101 in the film thickness direction. As can be seen from the figure, the film thickness (t1+t3) of the heat storage layer directly below the heat generating resistive layer 106 is thinner than the film thickness (t1+t2) of the heat storage layer in regions other than the region directly below the heat storage layer.

With the present embodiment, the heat generating elements of this substrate 100 were driven to conduct an operation test. In the operation test, an increase in the head temperature was evaluated in a situation where multiple heat generating elements were continuously driven, the operation did not stop due to excessive temperature rise, and continuous ejection was performed in a desirable manner. Furthermore, there was no unexpected liquid ejection due to re-boiling that occurs during filling after liquid ejection, and a good ejection state was identified.

As described above, in the conventional configuration in which a connection member having a plug structure is placed on the rear surface of a heat generating element, it has been necessary to design the film thickness to be thick taking into account a reduction in film thickness due to polishing. However, with the configuration of the present invention, it is possible to reduce an increase in film thickness of the heat storage layer in the element substrate of the liquid ejection head, and to limit a decrease in the heat dissipation efficiency. As a result, problems with liquid ejection and increased downtime of the apparatus can be prevented.

### Second Embodiment

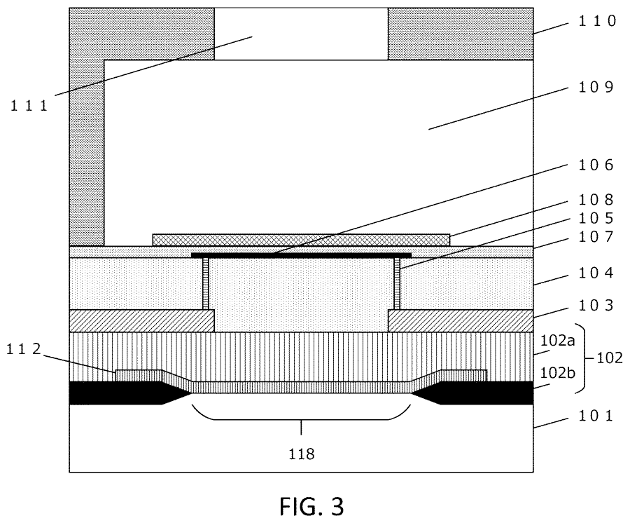

A second embodiment of the present invention is now described. However, for the sake of simplicity, only the differences from the first embodiment are described, and points that are not specifically mentioned are the same as those in the first embodiment. FIG. 3 is a schematic view showing a cross section taken along line A-A′ in FIG. 1B of the second embodiment.

In the first embodiment, the first insulating layer 102 is formed by stacking the SiO layer 102a, which is formed by plasma CVD, and the thermal oxide layer 102b, which is formed by thermal oxidation of Si. Also, patterning is performed so as not to form the thermal oxide layer 102b in the region that coincides with the heat generating resistive layer 106 in plan view.

In this embodiment, a first heat dissipation layer 112 made of a conductive material such as polycrystalline Si is further formed so as to cover at least the opening 118 of the patterned thermal oxide layer 102b. The first heat dissipation layer 112 is formed to a film thickness of 0.2 to 1.0 μm. Furthermore, the first heat dissipation layer 112 may be formed in the same layer as electrodes and wiring of functional elements such as transistors incorporated in the base substrate 101. The first heat dissipation layer 112 is electrically independent of the heat generating resistive layer 106 and the wiring layer 103.

According to this embodiment, by placing the first heat dissipation layer 112, which has a higher thermal conductivity than the first insulating layer 102, directly below the heat generating resistive layer 106, a substrate 100 with improved heat dissipation efficiency can be manufactured.

### Third Embodiment

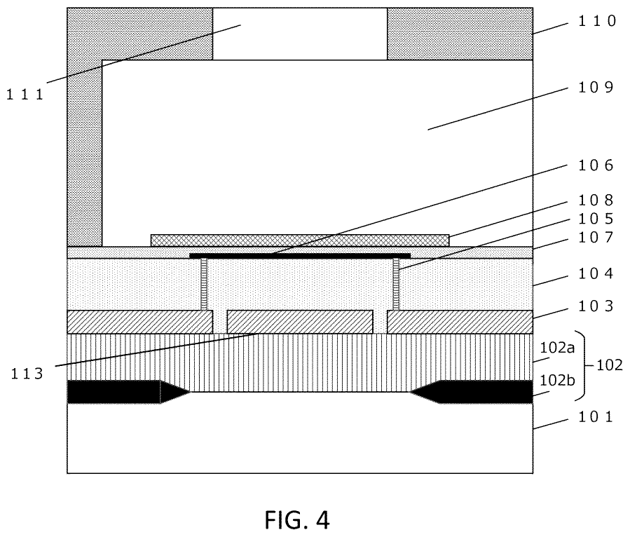

A third embodiment of the present invention is now described. However, for the sake of simplicity, only the differences from the first embodiment are described, and points that are not specifically mentioned are the same as those in the first embodiment. FIG. 4 is a schematic view showing a cross section taken along line A-A′ in FIG. 1B of the third embodiment.

In this embodiment, a second heat dissipation layer 113 is placed at a position directly below the heat generating resistive layer 106 between the first insulating layer 102 and the second insulating layer 104, and not in electrical contact with the wiring layer 103. The second heat dissipation layer 113 is preferably made of a metal material with high thermal conductivity, for example, a material containing Al as a main component. More preferably, the second heat dissipation layer 113 may be formed simultaneously with the wiring layer 103.

According to this embodiment, by placing the second heat dissipation layer 113, which has higher thermal conductivity than the first insulating layer 102, directly below the heat generating resistive layer 106, a substrate with improved heat dissipation efficiency can be manufactured.

### Fourth Embodiment

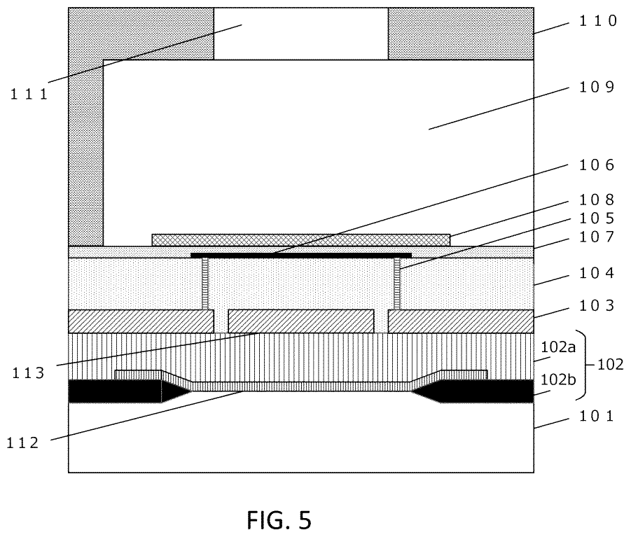

A fourth embodiment of the present invention is now described. However, for the sake of simplicity, only the differences from the first embodiment are described, and points that are not specifically mentioned are the same as those in the first embodiment. FIG. 5 is a schematic view showing a cross section taken along line A-A′ in FIG. 1B of the fourth embodiment.

The present embodiment has a configuration in which both the first heat dissipation layer 112 formed in the second embodiment and the second heat dissipation layer 113 formed in the third embodiment are placed.

In this embodiment, by placing both the first and second heat dissipation layers 112 and 113, the heat dissipation efficiency can be further improved. An evaluation of a substrate produced according to the present embodiment had a similar result to the evaluation performed for the above embodiment.

### First Comparative Example

A first comparative example is now described. However, for the sake of simplicity, only the differences from the first embodiment are described, and points that are not specifically mentioned are the same as those in the first embodiment.

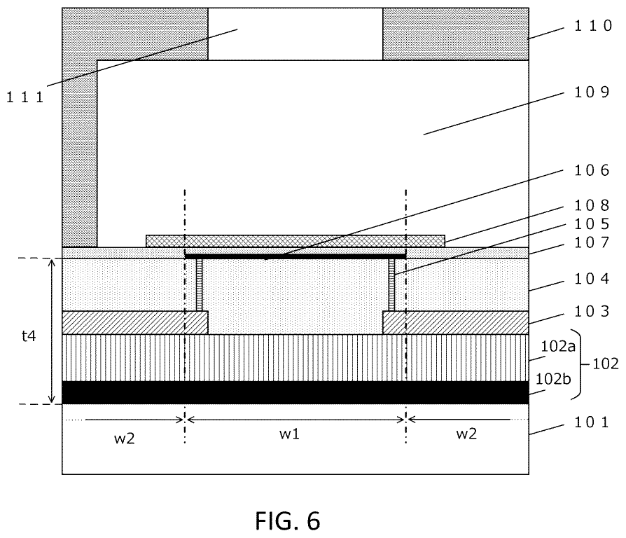

In the first embodiment, at least a part of the first insulating layer 102 is not placed directly below the heat generating resistive layer 106. This comparative example differs from the first embodiment in that the first insulating layer 102 is placed also directly below the heat generating resistive layer 106. FIG. 6 is a schematic view showing a cross section taken along line A-A′ in FIG. 1B of the first comparative example.

In the liquid ejection head substrate 100 manufactured according to this comparative example, the region (w1) located directly below the heat generating resistive layer 106 is a heat storage layer. The film thickness (t4) of the heat storage layer in this comparative example is 3.5 μm and equal to the distance from the lower surface of the heat generating resistive layer 106 to the base substrate 101 in the stacking direction. In this comparative example, the sum of the film thicknesses of the first insulating layer 102 and the second insulating layer 104 in the regions (w2) other than the region that is opposed to the heat generating resistive layer 106 is the same as the film thickness directly below the heat generating resistive layer 106 (t4). As such, this comparative example does not include a particular configuration for improving the heat dissipation efficiency.

The heat generating elements of this substrate were driven to conduct an operation test. In the operation test, an increase in the head temperature was evaluated in a situation where multiple heat generating elements were continuously driven, the operation was stopped frequently due to excessive temperature rise, and continuous ejection was not performed in a desirable manner. Furthermore, unexpected liquid ejection occurred in some elements due to re-boiling that occurred during filling after liquid ejection.

### Second Comparative Example

A second comparative example is now described. However, for the sake of simplicity, only the differences from the first embodiment are described, and points that are not specifically mentioned are the same as those in the first embodiment.

In this comparative example, SiO2 that forms a part of the first insulating layer 102 and is formed by thermal oxidation is formed in at least a part of the region that coincides with the heat generating resistive layer 106 in plan view. As a result, this comparative example differs from the first embodiment in that the region (w1) directly below the heat generating resistive layer 106 includes regions (w3) in which the thermal oxide layer 102b is formed. As for the other configurations and steps, the substrate is formed using the same steps as the first embodiment.

In this comparative example, minute steps are formed in the region where the heat generating resistive layer 106 coincides with the SiO2 layer in plan view, and an abnormality occurred in the resistance value of the heat generating resistive layer 106, making it impossible to eject liquid normally.

### Application Example

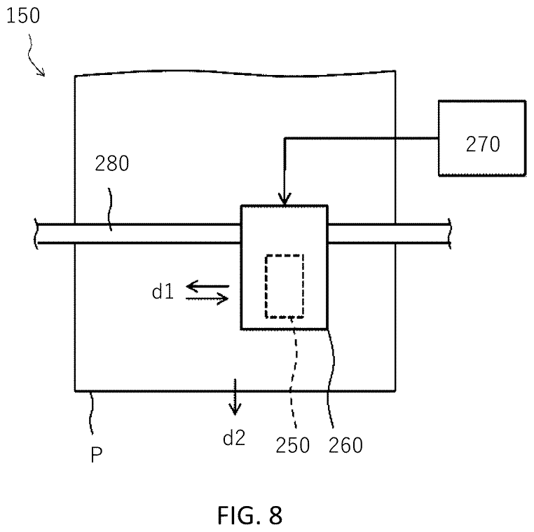

An example in which a substrate according to an embodiment of the present invention is applied to a liquid ejection head or a liquid ejection apparatus is now described. FIG. 8 is a configuration diagram schematically showing an example of the overall configuration of an inkjet liquid ejection apparatus 150 (recording apparatus). The liquid ejection apparatus 150 includes a liquid ejection head 250 (recording head), a carriage 260, and a controller 270, which is a control portion that controls the driving of these components.

The liquid ejection head 250 includes multiple ejection ports 111 (nozzles) for ejecting liquid such as ink, and a substrate 100 (recording element substrate) on which multiple heat generating elements corresponding to the ejection ports 111 are provided. When the liquid ejection head 250 drives each heat generating element on the basis of a control signal from the controller 270, the liquid in the liquid chamber 109 is heated and ejected from the ejection port 111. In this manner, recording (image formation) is performed on a recording medium P such as paper.

The carriage 260, which supports the liquid ejection head 250, is reciprocated along a guide 280 in the directions of arrows d1 on the basis of a control signal from the controller 270. The recording medium P is transported in a direction d2 by a transport mechanism of the liquid ejection apparatus 150. The controller 270 controls the driving of the liquid ejection head 250 while reciprocating the carriage 260, thereby recording a desired image on the recording medium P.

A liquid ejection head 250 and a liquid ejection apparatus 150 can be manufactured using a substrate 100 described in each embodiment of the present invention. In the liquid ejection head 250 and the liquid ejection apparatus 150, the heat dissipation efficiency in the substrate 100 is improved, so that it is possible to prevent problems with liquid ejection and an increase in downtime of the apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-214567, filed on Dec. 20, 2023, which is hereby incorporated by reference wherein in its entirety.

What is claimed is:

1. A liquid ejection head substrate in which a first insulating layer, a wiring layer, and a second insulating layer are stacked in this order on a base substrate, wherein
a heat generating resistive layer configured to generate energy for ejecting liquid by electrification is provided on the second insulating layer,
a connection plug that extends through the second insulating layer, electrically connects the wiring layer and the heat generating resistive layer, and enables electrification of the heat generating resistive layer is included, and
a film thickness from the first insulating layer to the second insulating layer in a first region that coincides with the heat generating resistive layer in plan view is thinner than a film thickness from the first insulating layer to the second insulating layer in a second region that does not coincide with the heat generating resistive layer in plan view.

2. The liquid ejection head substrate according to claim 1, wherein a part of the first insulating layer is a thermal oxide film of silicon.

3. The liquid ejection head substrate according to claim 2, wherein the thermal oxide film is not formed in the first insulating layer in the first region.

4. The liquid ejection head substrate according to claim 3, wherein a first heat dissipation layer having higher thermal conductivity than the first insulating layer is provided in the first region.

5. The liquid ejection head substrate according to claim 4, wherein the first heat dissipation layer is provided so as to cover an opening of the thermal oxide film.

6. The liquid ejection head substrate according to claim 4, wherein the first heat dissipation layer is formed of a conductive material that is electrically independent of the heat generating resistive layer and the wiring layer.

7. The liquid ejection head substrate according to claim 3, wherein a second heat dissipation layer having higher thermal conductivity than the first insulating layer is provided at a position in the first region that is between the first insulating layer and the second insulating layer and not in electrical contact with the wiring layer.

8. The liquid ejection head substrate according to claim 3, wherein, in the first region, a first heat dissipation layer having higher thermal conductivity than the first insulating layer is provided so as to cover an opening of the thermal oxide film, and a second heat dissipation layer having higher thermal conductivity than the first insulating layer is provided at a position that is between the first insulating layer and the second insulating layer and not in electrical contact with the wiring layer.

9. The liquid ejection head substrate according to claim 1, wherein a protection layer configured to protect the heat generating resistive layer from liquid and a liquid chamber that contains the liquid and includes an ejection port for the liquid are placed above the heat generating resistive layer.
